(19) United States
(12) Patent Application Publication
(10) Pub. No.: US 2007/0064575 A1
(43) Pub. Date: Mar. 22, 2007

(54) Objective optical system and optical pickup apparatus

(75) Inventor: Kazutaka Noguchi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/522,319

(22) Filed: Sep. 18, 2006

(30) Foreign Application Priority Data
Sep. 21, 2005 (JP) JP2005-273774

(51) Int. Cl. G11B 7/135; G11B 7/00

(52) U.S. Cl. 369/112.23; 369/44.23

(57) ABSTRACT

An objective optical system according to the present invention is provided for use in an optical pickup apparatus for recording and/or reproducing information on an information recording surface of a first optical information recording medium and a second optical information recording medium using a first light flux emitted from a first light source and a second light flux emitted from a second light source, respectively. The objective optical system is provided with: a first optical element; a second optical element with a positive refractive power; and a first phase structure arranged on an optical surface of the second optical element for reducing a spherical aberration caused by a thickness difference between the first optical information recording medium and the second optical information recording medium.

This application is based on Japanese Patent Application No. 2005-273774 filed on Sep. 21, 2005, in Japanese Patent Office, the entire content of which is hereby incorporated by reference.

### TECHNICAL FIELD

The present invention relates to an objective optical system and to an optical pickup apparatus, and in particular, to an objective optical system including a plurality of plastic lenses and to an optical pickup apparatus employing the aforesaid objective optical system.

### BACKGROUND

In recent years, research and development are advanced rapidly for a high density optical disc system that employs a violet semiconductor laser having a wavelength of about 400 nm, and is capable of conducting recording/reproducing of information. As an example, information of 23-27 GB per one layer can be recorded on an optical disc having a diameter of 12 cm that is the same size as in DVD (NA 0.6, light source wavelength 650 nm and memory capacity 4.7 GB) for an optical disc conducting recording/reproducing of information under specifications of NA 0.85 and light source wavelength 405 nm, namely, the so-called Blu-ray Disc (hereinafter referred to as BD), and, information of 15-20 GB per one layer can be recorded on an optical disc having a diameter of 12 cm for an optical disc conducting recording/reproducing of information under specifications of NA 0.65 and light source wavelength 405 nm, namely, the so-called HD DVD (hereinafter referred to as HD). In the mean time, a protective layer of BD is designed to be thinner than that of DVD (being 0.1 mm for BD, while 0.6 mm for DVD) to reduce an amount of comatic aberration caused by the skew, because comatic aberration caused by the skew of an optical disc is increased, in the case of BD. Hereafter, the optical disc of this kind is called “high density optical disc” in the present specification.

Meanwhile, a plastic lens has advantages that a mass production can be secured while keeping stable precisions at low cost, because injection molding at low temperature (approximately 120° C.) is possible, a long life of a metal mold can be secured and material cost is low. In Japanese patent application publication JP-A No. 2001-324673, therefore, there is suggested an objective optical system that includes a plastic single lens capable of realizing a numerical aperture of NA 0.85 and is used for an optical pickup apparatus.

However, the plastic single lens has a problem that spherical aberration caused by changes of refractive index resulting from temperature fluctuations grows greater, though it has the aforesaid advantages. The reason for this is that changes in spherical aberration caused by refractive index changes resulting from temperature changes grow greater in proportion to the fourth power of the numerical aperture (NA⁴), and the refractive index changes resulting from temperature changes tend to be more remarkable, in particular, when an optical surface having the greater curvature is formed for realizing a high numerical aperture. Meanwhile, in the following description, the characteristic of an optical element in the case of temperature changes will be sometimes called “temperature characteristic”.

On the other hand, as a technology to correct temperature characteristics of the plastic lens, International Publication Number WO 02/41307 Pamphlet, for example, discloses a technology to correct temperature characteristics by providing a step structure having a plurality of microscopic step differences extending in the optical axis direction (NPS: non-periodic phase structure) on an optical surface of a single lens. By providing the above step structure on the optical surface, the temperature characteristics can be improved.

In the meantime, with respect to a thickness of a protective layer provided on an information recording surface for each of BD, DVD and CD, t1 is 0.1 mm for BD, t2 is 0.6 mm for DVD, and t3 is 1.2 mm for CD, to be different each other. Therefore, when specifications are determined so that a common objective lens may converge a light flux optimally on any one of the optical discs, the common objective lens converging a light flux on other optical discs causes spherical aberration based on a thickness difference of a protective layers of the optical discs, which is a problem. However, when recording and/or reproducing information on different optical discs, light fluxes having different wavelengths can be used. Therefore, it is possible to correct spherical aberration caused by the thickness difference of the protective layer, by providing an optical path difference corresponding to the wavelength by using an optical path difference providing structure formed on the objective lens.

However, when the optical path difference providing structure for correcting a difference of the protective layer thickness is provided on a single objective lens with superimposed together with diffractive structure correcting temperature characteristics as stated above, there is a fear that a shape of the optical surface becomes complicated, resulting in a difficulty in forming a highly accurate optical surface. Therefore, it is planned that an objective lens is formed by plural optical elements, and each of an optical path difference providing structure that corrects a difference in the protective layer thickness, a diffractive structure correcting temperature characteristics and NPS are formed on optical surfaces of the optical elements. However, when constituting the objective lens with two optical elements, for example, it is preferable that a first optical element positioned to be closer to a light source hardly has refractive power and a second optical element on the optical disc side has positive refractive power. When the optical path difference providing structure that corrects a difference of protective layer thickness is formed on the first optical element, there is a fear that aberration characteristics are deteriorated by misalignment between the first optical element and the second optical element.

In the present specifications, “refractive power” means a value expressed by a reciprocal number of a focal distance of light converged by a refractive surface of an optical element. When a phase structure is formed on the refractive surface of a lens, a shape of the base surface on which the phase structure is formed is made to be a refractive surface.

### SUMMARY

The present invention has been achieved, in view of the problems of conventional technologies mentioned above, and an object of the present invention is to provide an optical pickup apparatus which can easily be manufactured and can conduct recording and/or reproducing of information for different optical discs on a compatible basis, and to provide an objective optical system that is used for the aforesaid optical pickup apparatus.

An embodiment relating to the present invention is an objective optical system for use in an optical pickup apparatus for recording and/or reproducing information for optical information recording media each having protective layers with thicknesses t1 and t2. The objective optical system includes a first optical element; a second optical element with a positive refractive power; and a first phase structure arranged on an optical surface of the second optical element facing a light source side for reducing a spherical aberration caused by a difference between the thicknesses t1 and t2.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a diagram showing schematically a structure of an optical pickup apparatus of the present embodiment; and

FIG. 2 is a cross-sectional view of an objective optical system of Example 1, wherein the first optical element and the second optical element are fixed by an unillustrated lens holder.

### DESCRIPTION OF THE PREFERRED EMBODIMENT

Preferred structures according to the present invention will be explained as follows.

Item 1 is an objective optical system for use in an optical pickup apparatus for recording and/or reproducing information on an information recording surface of a first optical information recording medium having a protective layer with a thickness t1 using a first light flux with a wavelength λ1 emitted from a first light source, and for recording and/or reproducing information on an information recording surface of a second optical information recording medium having a protective layer with a thickness t2 (t2>t1) using a second light flux with a wavelength λ2 (λ1<λ2) emitted from a second light source. The objective optical system includes: a first optical element; a second optical element with a positive refractive power and arranged on an optical information recording media side of the first optical element; and a first phase structure arranged on an optical surface of the second optical element facing a light source side for reducing a spherical aberration caused by a difference between the thickness t1 and the thickness t2.

According to the above construction, the first phase structure for reducing a spherical aberration caused by a difference between the thickness t1 and the thickness t2 is arranged on an optical surface of the second optical element facing a light source side. Therefore, an optical axis of the optical surface of the second optical element facing the light source side and an optical axis of the first phase structure are accurately aligned. It suppresses a deterioration of aberration characteristics even if the first optical element and the second optical element occur misalignment.

In the present specification, “phase structure” means a general term of structures including a plurality of step differences extending in the optical axis direction and adding an optical path difference (phase difference) to the incident light flux. An optical path difference added to the incident light flux by the step differences may be either a multiple of an integer of a wavelength of the incident light flux or a multiple of a non-integer of a wavelength of the incident light flux. Specific example of the phase structure of this kind is represented by a diffractive structure wherein the aforesaid step differences are arranged along the direction perpendicular to the optical axis at periodical intervals, or by an optical path difference providing structure wherein the aforesaid step differences are arranged along the direction perpendicular to the optical axis at non-periodic intervals (which is also called phase difference providing structure).

Item 2 is the objective optical system described in Item 1 in which each of the first optical element and the second optical element is a plastic lens. Therefore, it allows to reduce cost resulting from mass production and to save weight of the objective optical system.

Item 3 is the objective optical system described in Item 1 or 2, further including a second phase structure on one of optical surfaces of the first optical element and the second optical element. When a wavelength of the first light flux changes +5 nm from the wavelength λ1, a wavefront aberration change amount of the objective optical system on the information recording surface of the first optical information recording medium satisfies 0.031 λ1 rms or more, and 0.095 λ1 rms or less. When an ambient temperature of the objective optical system changes +30° C. from a design reference temperature, the wavefront aberration change amount of the objective optical system on the information recording surface of the first optical information recording medium satisfies 0.010 λ1 rms or more, and 0.060 λ1 rms or less.

When the present objective optical system is provided with the aforementioned first and second plastic optical elements, providing positive refractive power to each of the optical elements improve the temperature characteristic. However, satisfactory improvement of the temperature characteristic may not be achieved by mere sharing the refractive power by each optical element. When the refractive power of the convex lens on the light source side in particular is increased, the working distance of the objective optical system will be reduced. This will yield restrictions at the time of installation on the optical pickup apparatus.

In view of the above problem, further improvement of the temperature characteristic can be achieved by using the phase structure such as an optical path difference providing structure represented by a diffractive structure, as will be described later. Improvement of the temperature characteristic, however, may involve deterioration of wavelength characteristic. It is important how to find out a way for compatibility between the temperature characteristic and wavelength characteristic. Thus, the balance is maintained between the temperature characteristic and the wavelength characteristic of the aforementioned objective optical system to ensure that, when the aforementioned first light flux is changed +5 nm from the aforementioned wavelength λ1, the change amount of the wavefront aberration of the objective optical system on the information recording surface of the aforementioned first optical information recording medium is in the range from 0.031 λ1 rms or more without exceeding 0.095 λ1 rms, and, when the ambient temperature is changed +30° C. from the design reference temperature, the change amount of the wavefront aberration of the objective optical system on the information recording surface of the aforementioned first optical information recording medium is in the range from 0.010 λ1 rms or more without exceeding 0.060 λ1 rms. This arrangement provides totally excellent optical characteristics to the objective optical system for optical pickup apparatus, while reducing the cost.

The “ambient temperature” refers to the temperature of the atmosphere wherein the aforementioned objective optical system is installed. Herein, the wavefront aberration change amount of the objective optical system, when the ambient temperature changes, on the information recording surface of the first optical information recording medium means a wave front aberration change amount based on a refractive index change of a material of optical elements due to the ambient temperature change, and does not include a wavefront aberration change amount based on a change of an oscillation wavelength of a light source due to the ambient temperature change.

Item 4 is the objective optical system described in Item 1 or 2, further including a second phase structure on one of optical surfaces of the first optical element and the second optical element. A wavefront aberration change amount caused by the second phase structure on the information recording surface of the first optical information recording medium satisfies 0.033 λ1 rms or more, and 0.120 λ1 rms or less when a wavelength of the first light flux changes +5 nm from the wavelength λ1, and a wavefront aberration change amount caused by the second phase structure on the information recording surface of the first optical information recording medium satisfies 0.020 λ1 rms or more, and 0.060 λ1 rms or less when an ambient temperature of the objective optical system changes +30° C. from a design reference temperature.

According to the objective optical system, when the aforementioned first light flux is changed +5 nm from the aforementioned wavelength λ1, the change amount of the wavefront aberration caused by the second phase structure on the information recording surface of the aforementioned first optical information recording medium is in the range from 0.033 λ1 rms or more without exceeding 0.120 λ1 rms, and, when the ambient temperature is changed +30° C. from the design reference temperature, the change amount of the wavefront aberration caused by the second phase structure on the information recording surface of the aforementioned first optical information recording medium is in the range from 0.020 λ1 rms or more without exceeding 0.060 λ1 rms. Therefore, the balance is maintained between the temperature characteristic and the wavelength characteristic of the objective optical system by this arrangement. It provides totally excellent optical characteristics to the objective optical system for optical pickup apparatus, while reducing the cost.

In the present specification, a “second phase structure” is one provided with a central area including an optical axis and with plural ring-shaped zones divided by. microscopic step differences on the outside of the central area and every adjoining ring-shaped zones are divided through a step difference with a predefined depth extending parallel to an optical axis. The structure has characteristics generating an optical path difference being a multiple of an integer of a wavelength of the incident light flux between wavefronts transmitted through adjoining ring-shaped zones at the prescribed temperature. The structure also has characteristics generating an optical path difference deviated from a multiple of an integer of a wavelength of the incident light flux between wavefronts transmitted through adjoining ring-shaped zones resulting of a refractive index change, in the case where the temperature is changed from the aforesaid prescribed temperature.

Item 5 is the objective optical system described in Item 3 or 4 in which a wavefront aberration change amount caused by the second phase structure when a wavelength of the first light flux changes +1 nm from the wavelength λ1, is larger than a wavefront aberration change amount caused by the second phase structure when the ambient temperature of the objective optical system changes +10° C. from the design reference temperature, and is smaller than a wavefront aberration change amount caused by the second phase structure when the ambient temperature of the objective optical system changes +30° C. from the design reference temperature.

According to the objective optical system, when the aforementioned second phase structure is provided, the temperature characteristic of the aforementioned objective optical system can be improved, but the wavelength characteristic may deteriorate. To solve this problem, the balance is maintained between the temperature characteristic of the aforementioned second phase structure and the wavelength characteristic to ensure that the wavefront aberration change amount caused by the second phase structure when the aforementioned first light flux is changed +1 nm from the aforementioned wavelength λ1 is greater than the wavefront aberration change amount caused by the aforementioned second phase structure when the ambient temperature is changed +10° C. from the design reference temperature, and is smaller than the wavefront aberration change amount caused by the aforementioned second phase structure when the ambient temperature is changed +30° C. from the design reference temperature. This arrangement provides totally excellent optical characteristics to the objective optical system for optical pickup apparatus, while reducing the cost.

Item 6 is the objective optical system described in any one of Items 3 to 5 in which the optical surface including the second phase structure is one of an optical surface facing a light source side of the first optical element, an optical surface facing an optical information recording medium side of the first optical element, and an optical surface facing a light source side of the second optical element.

Item 7 is the objective optical system described in any one of Items 1 to 6 in which the objective optical system satisfies the following expression:
0.04<P1/P<0.15 (1)

where P1 is a refractive power of the first optical element, and P is a composite power of the first optical element and the second optical element.

By making a value of P1/P to be greater than the lower limit of expression (1), it is possible to control spherical aberration to be excellent when the objective optical system is subjected to +30° C. of temperature change from the design reference temperature, and when an oscillation wavelength of the light source is deviated by +5 nm from a reference wavelength, whereby, it is possible to conduct properly recording and/or reproducing of information in the optical pickup apparatus employing this objective optical system. Further, when a ratio of refractive power of the first optical element to power of the whole system of the objective optical system is made to be great, the working distance tends to be small, although an amount of wavefront aberration that changes in the case of temperature changes or wavelength changes can be made small, which was described above. However, when that ratio is made to be smaller than the upper limit of the expression (1), a necessary working distance can be secured.

Furthermore, providing power to the first optical element weakens the power of the second optical element with securing the composite power. Therefore, a curvature radius of an optical surface of the second optical element is increased and it allows to form the first phase structure having a microscopic structure easily.

Item 8 is the objective optical system described in any one of Items 1 to 7 in which the first phase structure generates a first order diffracted light flux with a maximum light amount when the first light flux with the wavelength λ1 passes the first phase structure, and the first phase structure generates a first order diffracted light flux with a maximum light amount when the second light flux with the wavelength λ2 passes the first phase structure. Therefore, the above configuration properly corrects a spherical aberration caused due to a thickness difference of protective layers.

Item 9 is the objective optical system described in any one of Items 3 to 8 in which the second phase structure is divided in a plurality of ring-shaped zones on the optical surface including the second phase structure. Each of the ring-shaped zones has a center arranged on the optical axis and every adjoining ring-shaped zones are divided through a step difference with a predefined depth parallel to an optical axis. When the wavelengths λ1 and λ2 satisfy the following expressions:
390 nm<λ1<420 nm and (2)
640 nm<λ2<680 nm, (3)
the objective optical system satisfies
1.7×λ1/{n(λ1)−1}≦d≦2.3×λ1/{n(λ1)−1}, (4)
where d is the predefined depth of the step difference, and n(λ1) is a refractive index of a material of the second phase structure for the wavelength λ1.

When step differences of the aforesaid second phase structure are formed so that adjoining ring-shaped zones may provide an optical path difference equivalent to almost two times of the wavelength λ1 of the light flux to a light flux passing through the adjoining ring-shaped zones under the reference state, it is possible to reduce fitting errors in the occasion wherein the wavefront aberration for a light flux having wavelength λ1 caused when the temperature changes from the design reference temperature or when the wavelength changes from the reference wavelength is fitted to Fringe Zernike polynomial having up to 36 terms.

Item 10 is the objective optical system described in any one of Items 3 to 8 in which the second phase structure is divided in a plurality of ring-shaped zones on the optical surface including the second phase structure. Each of the ring-shaped zones has a center arranged on the optical axis and every adjoining ring-shaped zones are divided through a step difference with a predefined depth parallel to an optical axis. When the wavelengths λ1 and λ2 satisfy the following expressions:
390 nm<λ1<420 nm and (5)
640 nm<λ2<680 nm, (6)
the objective optical system satisfies
4.7×λ1/{n(λ1)−1}≦d≦5.3×λ1/{n(λ1)−1}, (7)
where d is the predefined depth of the step difference, and n(λ1) is a refractive index of a material of the second phase structure for the wavelength λ1.

When step differences of the aforesaid second phase structure are formed so that adjoining ring-shaped zones may provide an optical path difference equivalent to almost five times of the wavelength λ1 of the light flux to a light flux passing through the adjoining ring-shaped zones under the reference state, it is possible to reduce fitting errors in the occasion wherein the wavefront aberration for a light flux having wavelength λ1 caused when the temperature changes from the design reference temperature or when the wavelength changes from the reference wavelength is fitted to Fringe Zernike polynomial having up to 36 terms.

Item 11 is the objective optical system described in Item 1 or 2 in which the objective optical system is for use in the optical pickup apparatus further for recording or reproducing information on an information recording surface of a third optical information recording medium having a protective layer with a thickness t3 by converging a third light flux with a wavelength λ3 (λ2<λ3) emitted from a third light source on the information recording surface of the third optical information recording medium through the protective layer with the thickness t3. The first phase structure reduces a spherical aberration caused by a difference between the thickness t1 and the thickness t3. Therefore, the configuration allows to recording and/or reproducing information properly on each of three kinds of optical information recording media including, for example, high density optical disc, DVD and CD.

Item 12 is the objective optical system described in Item 11 in which the objective optical system satisfies:
0.04<P1/P<0.11, (8)
where P1 is a refractive power of the first optical element, and P is a composite power of the first optical element and the second optical element.

By making a value of P1/P to be greater than the lower limit of expression (8), it is possible to control spherical aberration to be excellent when the objective optical system is subjected to +30° C. of temperature change from the design reference temperature, and when an oscillation wavelength of the light source is deviated by +5 nm from a reference wavelength, whereby, it is possible to conduct properly recording and/or reproducing of information in the optical pickup apparatus employing this objective optical system. Further, when a ratio of refractive power of the first optical element to power of the whole system of the objective optical system is made to be great, the working distance tends to be small, although an amount of wavefront aberration that changes in the case of temperature changes or wavelength changes can be made small, which was described above. However, when that ratio is made to be smaller than the upper limit of the expression (8), a necessary working distance can be secured, even when the third light flux having the wavelength λ3 is considered.

Item 13 is the objective optical system-described in Item 11 or 12 in which the thicknesses t1, t2, and t3 satisfy t1≦t2<t3. The first phase structure generates a first order diffracted light flux with a maximum light amount when the first light flux passes the first phase structure, The first phase structure further generates a first order diffracted light flux with a maximum light amount when the second light flux passes the first phase structure, and further generates a first order diffracted light flux with a maximum light amount when the third light flux passes the first phase structure. Therefore, the configuration allows to recording and/or reproducing information properly on each of three kinds of optical information recording media including, for example, high density optical disc, DVD and CD.

Item 14 is the objective optical system described in any one of Items 11 to 13 in which the second phase structure is divided in a plurality of ring-shaped zones on the optical surface including the second phase structure. Each of the ring-shaped zones has a center arranged on the optical axis and every adjoining ring-shaped zones are divided through a step difference with a predefined depth parallel to an optical axis. When the wavelengths λ1, λ2 and λ3 satisfy the expressions:
390 nm<λ1<420 nm, (9)
640 nm<λ2<680 nm, and (10)
760 nm<λ3<805 nm, (11)
the objective optical system satisfies
1.7×λ1/{n(λ1)−1}≦d≦2.3×λ1/{n(λ1)−1}, (12)
where d is the predefined depth of the step difference, and n(λ1) is a refractive index of a material of the second phase structure for the wavelength λ1.

When step differences of the aforesaid second phase structure are formed so that adjoining ring-shaped zones may provide an optical path difference equivalent to almost two times of the wavelength λ1 of the light flux to a light flux passing through the adjoining ring-shaped zones under the reference state, it is possible to reduce fitting errors in the occasion wherein the wavefront aberration for a light flux having wavelength λ1 caused when the temperature changes from the design reference temperature or when the wavelength changes from the reference wavelength is fitted to Fringe Zernike polynomial having up to 36 terms.

Item 15 is the objective optical system described in any one of Items 11 to 13 in which the second phase structure is divided in a plurality of ring-shaped zones on the optical surface including the second phase structure. Each of the ring-shaped zones has a center arranged on the optical axis and every adjoining ring-shaped zones are divided through a step difference with a predefined depth parallel to an optical axis. When the wavelengths λ1, λ2 and λ3 satisfy the following expressions:
390 nm<λ1<420 nm, (13)
640 nm<λ2<680 nm, and (14)
760 nm<λ3<805 nm, (15)
the objective optical system satisfies
9.7×λ1/{n(λ1)−1}≦d≦10.3×λ1/{n(λ1)−1}, (16)
where d is the predefined depth of the step difference, and n(λ1) is a refractive index of a material of the second phase structure for the wavelength λ1.

When step differences of the aforesaid second phase structure are formed so that adjoining ring-shaped zones may provide an optical path difference equivalent to almost ten times of the wavelength λ1 to a light flux passing through the adjoining ring-shaped zones under the reference state, it is possible to reduce fitting errors in the occasion wherein the wavefront aberration for a light flux having wavelength λ1 caused when the temperature changes from the design reference temperature or when the wavelength changes from the reference wavelength is fitted to Fringe Zernike polynomial having up to 36 terms.

Item 16 is an optical pickup apparatus including: a first light source emitting a first light flux with a wavelength λ1 for recording and/or reproducing information on an information recording surface of a first optical information recording medium having a protective layer with a thickness t1; a second light source emitting a second light flux with a wavelength λ2 (λ1 <λ2) for recording and/or reproducing information on an information recording surface of a second optical information recording medium having a protective layer with a thickness t2 (t2>t1); and the objective optical system described in any one of Items 1 to 15.

Item 17 is the optical pickup apparatus described in Item 16 further including: a third light source emitting a third light flux with a wavelength λ3 (λ2<λ3) for recording and/or reproducing information on an information recording surface of a third optical information recording medium having a protective layer with a thickness t3. The first phase structure in the objective optical system reduces a spherical aberration caused by a difference between the thickness t1 and the thickness t3.

In the present specification, an objective optical system means an optical system including a lens with a light converging function that is arranged to be closest to the optical information recording medium side under the state where the optical information recording medium is mounted on the optical pickup apparatus to face the optical information recording medium, and it means a lens group movable at least in the direction of its optical axis together with the aforesaid lens by an actuator.

The invention makes it possible to provide an optical pickup apparatus manufactured easily and capable of conducting recording and/or reproducing of information for different optical discs on a compatible basis and to provide an objective optical system used for the aforesaid optical pickup apparatus.

While the preferred embodiments of the present invention have been described using specific terms, such description is for illustrative purposes only, and it is to be understood that changes and variations may be made without departing from the sprit or scope of the appended claims.

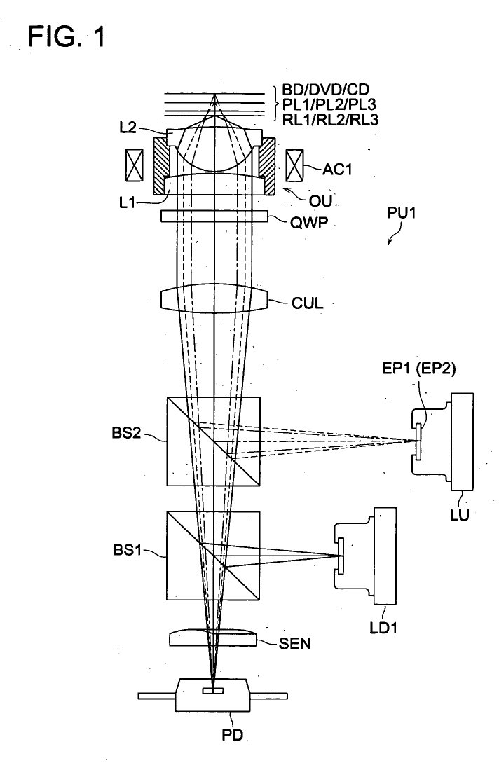

A specific embodiment according to the invention will be explained as follows, referring to the drawings. FIG. 1 is a diagram showing schematically the structure of optical pickup apparatus PU1 of the present embodiment capable of conducting recording/reproducing of information for BD, DVD and CD each being different optical information recording media (which is also called optical discs). The optical pickup apparatus PU1 is mounted on an optical information recording and reproducing apparatus. The first optical information recording medium is BD, the second optical information recording medium is DVD and the third optical information recording medium is CD. In this case, the first optical information recording medium may also be HD.

The optical pickup apparatus PU1 is provided with violet semiconductor laser LD1 emitting a violet laser light flux (first light flux) having wavelength of 405 nm that is radiated when conducting recording/reproducing of information for BD; laser light source unit LU for DVD and CD wherein first emission point EP1 that emits a red laser light flux (second light flux) having wavelength of 658 nm radiated when conducting recording/reproducing of information for DVD and second emission point EP2 that emits an infrared laser light flux (third light flux) having wavelength of 783 nm radiated when conducting recording/reproducing of information for CD, are formed on the same chip; photodetector PD for commonly use for BD, DVD, and CD; objective optical system OU that is provided with first optical element L1 and second optical element L2 both fixed in one body by a lens holder and has functions to converge a laser light flux on each of optical information recording surfaces RL1, RL2 and RL3; biaxial actuator AC1; coupling lens CUL; first polarized beam splitter BS1; second polarized beam splitter BS2; λ/4 wavelength plate QWP; and sensor lens SEN for adding astigmatism to reflected light fluxes coming respectively from information recording surfaces RL1, RL2 and RL3. Incidentally, a violet SHG laser may also be used as a light source for BD, instead of the aforesaid violet semiconductor laser LD1.

Herein, the coupling lens CUL is preferably formed of a plastic.

When recording/reproducing information for BD in the optical pickup apparatus PU1, violet semiconductor laser LD1 is caused to emit light. A divergent light flux emitted from the violet semiconductor laser LD1 is reflected by the first polarized beam splitter BS1 as is shown with a light path drawn with solid lines in FIG. 1, then, is converted into a parallel light flux by coupling lens CUL after passing through the second polarized beam splitter BS2. The converted parallel light flux passes through λ/4 wavelength plate QWP and is regulated in terms of a diameter of the light flux by an unillustrated diaphragm STO, to become a spot formed by objective optical system OU on the information recording surface RL1 through protective layer PL1. The objective optical system OU conducts focusing operation and tracking operation by biaxial actuator AC1 arranged on its circumference.

The reflected light flux modulated by information pits on information recording surface RL1 passes through the objective optical system OU and the λ/4 wavelength plate QWP again, and becomes a convergent light flux when it passes through coupling lens CUL. The convergent light flux is given astigmatism by sensor lens SEN after passing through second polarized beam splitter BS2 and first polarized beam splitter BS1, to converge on a light-receiving surface of photodetector PD. Thus, information recorded on BD can be read by the use of output signals of the photodetector PD.

Further, when recording/reproducing information for DVD in the optical pickup apparatus PU1, first emission point EP1 is caused to emit light. A divergent light flux emitted from the first emission point EP1 is reflected by the second polarized beam splitter BS2 as is shown with a light path drawn with broken lines in FIG. 1, then, is converted into a parallel light flux by coupling lens CUL. The converted parallel light flux passes through λ/4 wavelength plate QWP to become a spot formed by objective optical system OU on the information recording surface RL2 through protective layer PL2 of DVD. The objective optical system OU conducts focusing operation and tracking operation by biaxial actuator AC1 arranged on its circumference.

The reflected light flux modulated by information pits on information recording surface RL2 passes through the objective optical system OU and the λ/4 wavelength plate QWP again, and becomes a convergent light flux when it passes through coupling lens CUL. The convergent light flux is given astigmatism by sensor lens SEN after passing through second polarized beam splitter BS2 and first polarized beam splitter BS1, to converge on a light-receiving surface of photodetector PD. Thus, information recorded on DVD can be read by the use of output signals of the photodetector PD.

Further, when recording/reproducing information for CD in the optical pickup apparatus PU1, second emission point EP2 is caused to emit light. A divergent light flux emitted from the second emission point EP2 is reflected by the second polarized beam splitter BS2 as is shown with a light path drawn with one-dot chain lines in FIG. 1, then, is converted into a parallel light flux by coupling lens CUL. The converted parallel light flux passes through λ/4 wavelength plate QWP to become a spot formed by objective optical system OU on the information recording surface RL3 through protective layer PL3 of CD. The objective optical system OU conducts focusing operation and tracking operation by biaxial actuator AC1 arranged on its circumference.

The reflected light flux modulated by information pits on information recording surface RL3 passes through the objective optical system OU and the λ/4 wavelength plate QWP again and becomes a convergent light flux when it passes through coupling lens CUL. The convergent light flux is given astigmatism by sensor lens SEN after passing through second polarized beam splitter BS2 and first polarized beam splitter BS1, to converge on a light-receiving surface of photodetector PD. Thus, information recorded on CD can be read by the use of output signals of the photodetector PD.

Objective optical system OU includes first optical element L1 and second optical element L2 arranged in this order from light source side. Each of the first optical element L1 and the second optical element L2 is made of plastic in this embodiment. The first optical element L1 has opposite optical surfaces including an optical surface facing the light source in flat shape and an optical surface facing the optical disc (in the other words, the optical information recording medium) in convex aspheric shape. The second optical element L2 has a positive refractive power and has an optical surface facing light source side in convex aspheric shape.

In the present embodiment, the first phase structure is arranged on an optical surface facing the light source side of the first optical element L1 and the first phase structure is arranged on an optical surface facing the light source side of the second optical element L2.

The first phase structure reduces spherical aberration caused by difference between the protective layer thickness t1 and the protective layer thickness t2 of the information recording surface of BD and DVD and spherical aberration caused by difference between the protective layers thickness t1 and the protective layer thickness t3 of the information recording surface of BD and CD.

### EXAMPLE

A preferred example for the present embodiment will be explained as follows. Incidentally, hereafter (including lens data in Table), an exponent for 10 (for example, 2.5×10⁻³) is expressed by E (for example, 2.5E-3)

An optical surface of the objective optical system is formed to be an aspheric surface that is prescribed by a numerical expression wherein a coefficient shown in the table is substituted in Numeral 1, and is on axis symmetry about an optical axis;
z=(h²/r)/[1+√{1−(K+1)(h/r)²}]+A₀+A₄h⁴+A₆h⁶+A₈h⁸+A₁₀h¹⁰+A₁₂h¹²+A₁₄h¹⁴+A₁₆h¹⁶+A₁₈h¹⁸+A₂₀h²⁰ (Numeral 1)

where z represents an aspheric surface form (a distance from a plane that is tangent to aspheric surface at its vertex in the direction parallel to the optical axis), h represents a distance from the optical axis, R represents a radius of curvature, K represents a conic constant, and A₀, A₄, A₆, A₈, A₁₀, A₁₂, A₁₄, A₁₆, A₁₈ and A₂₀ represent aspheric surface coefficients.

Further, an optical path difference given to a light flux having each wavelength by the diffractive structure (phase structure) is prescribed by a numerical expression wherein a coefficient shown in the table is substituted in an optical path difference function of the expression of Numeral 2;
φ=m×λ/λ_{B}×(B₂h²+B₄h⁴+B₆h⁶+B₈h⁸+B₁₀h¹⁰) (Numeral 2)

where φ represents an optical path difference function, λ represents a wavelength of a light flux entering the diffractive structure, λ_{B} represents a blaze wavelength (manufacture wavelength), m represents a diffraction order number of a diffracted light flux used for recording/reproducing information on an optical disc, h represents a distance from an optical axis, and each of B₂, B₄, B₆, B₈ and B₁₀ represents optical path difference function coefficients.

### Example 1

Table 1 shows lens data (including design wavelength, focal length, numerical aperture on the image plane side and magnification) of Example 1.

In the Table 1, f1-f3 represent focal lengths in the optical pickup apparatus respectively for BD, DVD and CD, d1-d3 represent axial distances respectively for BD, DVD and CD, Nλ1-Nλ3 represent refractive indexes respectively for BD, DVD and CD, m1-m3 represent magnifications in the optical pickup apparatus respectively for BD, DVD and CD, and νd represents Abbe's numbers.

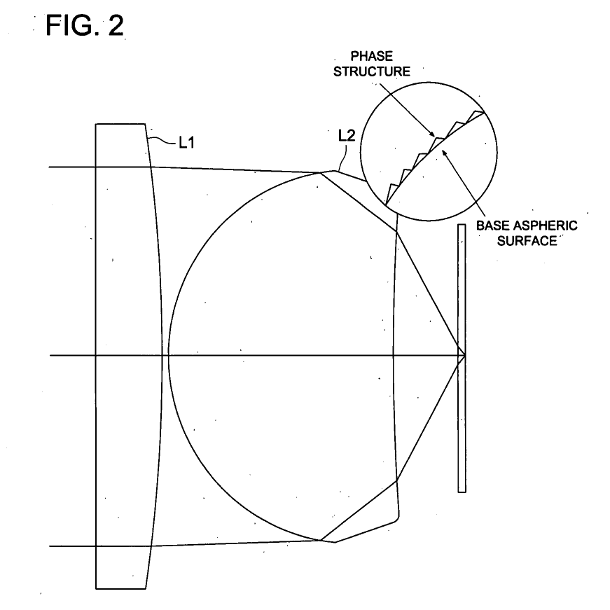

FIG. 2 shows a cross-sectional view of an objective optical system in Example 1. In Example 1, the first optical element has an optical surface (1st surface) facing light source side being flat and an optical surface (2nd surface) facing optical disc side being convex aspheric surface.

The second phase structure is provided on the entire surface (1st surface) of the first optical element facing the light source side. The second phase structure is divided in a plurality of ring-shaped zones on the surface (1st surface) of the first optical element facing the light source side. Each of the adjoining ring-shaped zones has a center on the optical axis and every adjoining ring-shaped zones are divided through a step difference with a predefined depth parallel to an optical axis. The step differences of the second phase structure are formed so that adjoining ring-shaped zones may provide, under the reference state, an optical path difference equivalent to almost ten times of the wavelength λ1 to the first light flux passing through the adjoining ring-shaped zones, provide an optical path difference equivalent to almost six times of the wavelength λ2 to the second light flux passing through the adjoining ring-shaped zones, provide an optical path difference equivalent to almost five times of the wavelength λ3 to the third light flux passing through the adjoining ring-shaped zones. However, it does not limit the scope of the present invention. The second phase structure may also be formed so that adjoining ring-shaped zones may provide, under the reference state, an optical path difference equivalent to almost two times of the wavelength λ1 to the first light flux passing through the adjoining ring-shaped zones, provide an optical path difference equivalent to the wavelength λ2 to the second light flux passing through the adjoining ring-shaped zones, provide an optical path difference equivalent to the wavelength λ3 to the third light flux passing through the adjoining ring-shaped zones.

In the part of the second phase structure in the Table 1, i represents the number of ring-shaped zone, hi-1 represents a height in the direction perpendicular to the optical axis of a point where the ring-shaped zones start, from the optical axis and hi represents a height in the direction perpendicular to the optical axis of a point where ring-shaped zones terminate, from the optical axis, where a direction of the step differences provided between adjoining ring-shaped zones extending along the optical axis is positive when the step differences extend toward the protective layer from the light source.

As shown in FIG. 2, a phase structure represented by data for the optical path difference function in Table 1 is formed on a base aspheric surface which is the light source side surface (3rd surface) of the second optical element.

The phase structure has a structure including ring-shaped zones divided by step differences extending in an optical axis direction and the structure has a cross section in a serrated shape. The phase structure is designed, within NA 0.6, to generate a first order diffracted light flux with a maximum light amount when the first light flux with wavelength λ1 passes the phase structure. The phase structure is further designed, within NA 0.45, to generate a first order diffracted light flux with a maximum light amount when the first light flux with wavelength λ1 passes the phase structure, to generate a first order diffracted light flux with a maximum light amount when the second light flux with wavelength λ2 passes the phase structure, and to generate a first order diffracted light flux with a maximum light amount when the third light flux with wavelength λ3 passes the phase structure.

TABLE 1
Example 1
Optical specifications
BD: NA1 = 0.85, f1 = 2.200 mm, λ1 = 405 nm, m1 = 0, t1 = 0.0875 mm
DVD: NA2 = 0.60, f2 = 2.369 mm, λ2 = 658 nm, m2 = 0, t2 = 0.6 mm
CD: NA3 = 0.45, f3 = 2.436 mm, λ3 = 783 nm, m3 = −0.0249, t3 = 1.2 mm
Changes in refractive index for temperature rise of 1° C.
for first optical element and second optical element:
dn/dt = −9.3E−5
Lens data table

| Surface | | | | | | | | | |
|---|---|---|---|---|---|---|---|---|---|
| No. | r(mm) | d1(mm) | d2(mm) | d3(mm) | Nλ1 | Nλ2 | Nλ3 | νd | Remarks |
| 0 | | ∞ | ∞ | 98.9287 | | | | | Light source |
| 1 | ∞ | 0.7000 | 0.7000 | 0.7000 | 1.55965 | 1.54062 | 1.53724 | 56.3 | First |
| 2 | −16.7894 | 0.0500 | 0.0500 | 0.0500 | | | | | optical |
| | | | | | | | | | element |
| 3 | (See below) | 2.5100 | 2.5100 | 2.5100 | 1.55965 | 1.54062 | 1.53724 | 56.3 | Second |
| 4 | −4.4116 | 0.6837 | 0.5359 | 0.2934 | | | | | optical |
| | | | | | | | | | element |
| 5 | ∞ | 0.0875 | 0.6000 | 1.2000 | 1.61838 | 1.57729 | 1.57087 | 30.0 | Protective |
| 6 | ∞ | | | | | | | | layer |

Refractive indexes of optical elements for
wavelength change of 5 nm

| | N(λ1 + 5 nm) | N(λ2 + 5 nm) | N(λ3 + 5 nm) |
|---|---|---|---|
| First optical | 1.558863 | 1.540451 | 1.537135 |
| element | | | |
| Second optical | 1.558863 | 1.540451 | 1.537135 |
| element | | | |
| Protective layer | 1.61647 | 1.576956 | 1.570686 |

Aspheric surface coefficients

| | Second | First area on | Second area on | Fourth |
|---|---|---|---|---|
| | surface | Third surface | Third surface | surface |
| Range | — | 0.0 < h < 1.5 | h > 1.5 | — |
| r | −16.78936 | 1.34668 | 1.39682 | −4.41160 |
| κ | −2.43244 | −0.73791 | −0.70611 | −114.77268 |
| A0 | 0.00000E+00 | 0.00000E+00 | 5.73515E−03 | 0.00000E+00 |
| A4 | 0.00000E+00 | 1.13282E−02 | 1.66343E−02 | 1.18761E−01 |
| A6 | 0.00000E+00 | 4.19634E−03 | 3.39543E−03 | −1.21746E−01 |
| A8 | 0.00000E+00 | 2.85390E−04 | 4.31018E−04 | 9.42766E−02 |
| A10 | 0.00000E+00 | 2.60097E−04 | −1.39387E−05 | −4.48213E−02 |
| A12 | 0.00000E+00 | −3.13673E−05 | 1.94244E−04 | 6.82377E−03 |
| A14 | 0.00000E+00 | −1.19235E−04 | −4.38365E−05 | 2.71082E−03 |
| A16 | 0.00000E+00 | 8.15677E−05 | −1.29033E−05 | −8.87025E−04 |
| A18 | 0.00000E+00 | −8.71336E−06 | 8.42470E−06 | 0.00000E+00 |
| A20 | 0.00000E+00 | −1.38636E−06 | −6.12755E−07 | 0.00000E+00 |

Optical path difference function

| | First area on | Second area on |
|---|---|---|
| | Third surface | Third surface |
| | 0.0 < h < 1.5 | h > 1.5 |
| Diffraction order | 1/1/1 | 1 |
| (λ1/λ2/λ3) | | |
| Manufacture | 450 nm | 408 nm |
| wavelength | | |
| B2 | 2.0000E−02 | 1.4156E−02 |
| B4 | −1.6894E−03 | 1.1236E−03 |
| B6 | 1.3236E−03 | 8.6793E−05 |
| B8 | −5.4960E−04 | −2.8948E−05 |
| B10 | 6.2562E−05 | −1.2202E−05 |

Second phase structure

| | | | Optical path | Step difference in |
|---|---|---|---|---|
| i | hi − 1(mm) | hi(mm) | difference | optical axis direction |
| 1 | 0.000 | 0.544 | 0 | 0.00000 |
| 2 | 0.544 | 1.552 | 10λ1 | 0.00729 |
| 3 | 1.552 | 1.870 | 0 | 0.00000 |

Table 2 summarizes the values specified in items 3 through 5 for Example 1. The design reference temperature is assumed as 25° C. in this case.

TABLE 2
Change amount of wavefront aberration

| | Objective optical | | | | | | |
|---|---|---|---|---|---|---|---|
| | system as a whole | | Second phase structure | | | | |
| | Design | | Design | Design | | | |
| | reference | Reference | reference | reference | Reference | Reference | |
| | temperature | wavelength | temperature | temperature | wavelength | wavelength | |
| | +30° C. | +5 nm | +10° C. | +30° C. | +1 nm | +5 nm | |
| Example 1 | 0.057 | 0.089 | 0.007 | 0.020 | 0.012 | 0.057 | [λ rms] |

P1/P is 0.07 for Example 1.

The embodiment and example stated above do not limit the scope of the present invention.

The second phase structure may be arranged on any optical surfaces of the first optical element L1 and the second optical element L2, and is preferably arranged on any one of an optical surface facing a light source side of the first optical element L1, an optical surface facing an optical information recording medium side of the first optical element L1, and an optical surface facing a light source side of the second optical element L2. Herein, when the second phase structure is arranged on the optical surface facing an light source side of the second optical element L2, the first phase structure and the second phase structure are superimposed on the optical surface.

When the second optical element is formed of resin or glass having small refractive index change due to temperature change, such an embodiment does not always requires the second phase structure.

The objective optical system relating to the present invention may also be applied to an optical pickup apparatus capable of conducting recording and/or reproducing of information only for high density optical disc or an optical pickup apparatus capable of conducting recording and/or reproducing of information compatibly for high density optical disc and DVD or CD.

When the objective optical system relating to the present invention is used in an optical-pickup apparatus conducting recording and/or reproducing of information properly for different two types of optical discs, such as BD and DVD, for example, step differences of the second phase structure are formed so that adjoining ring-shaped zones may provide, under the reference state, an optical path difference equivalent to almost two times of the wavelength λ1 to the first light flux passing through the adjoining ring-shaped zones, and provide an optical path difference equivalent to the wavelength λ2 to the second light flux passing through the adjoining ring-shaped zones. Alternately, step differences of the second phase structure may also be formed so that adjoining ring-shaped zones may provide, under the reference state, an optical path difference equivalent to almost five times of the wavelength λ1 to the first light flux passing through the adjoining ring-shaped zones, and provide an optical path difference equivalent to almost three times of the wavelength λ2 to the second light flux passing the adjoining ring-shaped zones.

What is claimed is:

1. An objective optical system for use in an optical pickup apparatus for recording and/or reproducing information on an information recording surface of a first optical information recording medium having a protective layer with a thickness t1 using a first light flux with a wavelength λ1 emitted from a first light source, and
for recording and/or reproducing information on an information recording surface of a second optical information recording medium having a protective layer with a thickness t2 (t2>t1) using a second light flux with a wavelength λ2 (λ1<λ2) emitted from a second light source, the objective optical system comprising:
a first optical element;
a second optical element with a positive refractive power arranged on an optical information recording media side of the first optical element; and
a first phase structure arranged on an optical surface of the second optical element facing a light source side for reducing a spherical aberration caused by a difference between the thickness t1 and the thickness t2.

2. The objective optical system of claim 1,
wherein each of the first optical element and the second optical element is a plastic lens.

3. The objective optical system of claim 1, further comprising a second phase structure on one of optical surfaces of the first optical element and the second optical element,
wherein when a wavelength of the first light flux changes +5 nm from the wavelength λ1, a wavefront aberration change amount of the objective optical system on the information recording surface of the first optical information recording medium satisfies 0.031 λ1 rms or more, and 0.095 λ1 rms or less, and
when an ambient temperature of the objective optical system changes +30° C. from a design reference temperature, the wavefront aberration change amount of the objective optical system on the information recording surface of the first optical information recording medium satisfies 0.010 λ1 rms or more, and 0.060 λ1 rms or less.

4. The objective optical system of claim 3,
wherein a wavefront aberration change amount caused by the second phase structure when a wavelength of the first light flux changes +1 nm from the wavelength λ1,
is larger than a wavefront aberration change amount caused by the second phase structure when the ambient temperature of the objective optical system changes +10° C. from the design reference temperature, and
is smaller than a wavefront aberration change amount caused by the second phase structure when the ambient temperature of the objective optical system changes +30° C. from the design reference temperature.

5. The objective optical system of claim 3,
wherein the optical surface including the second phase structure is one of an optical surface facing a light source side of the first optical element, an optical surface facing an optical information recording medium side of the first optical element, and an optical surface facing a light source side of the second optical element.

6. The objective optical system of claim 3,
wherein the second phase structure is divided in a plurality of ring-shaped zones on the optical surface including the second phase structure,
each of the ring-shaped zones has a center arranged on the optical axis,
every adjoining ring-shaped zones are divided through a step difference with a predefined depth parallel to an optical axis, and
when the wavelengths λ1 and λ2 satisfy the following expressions:
390 nm<λ1<420 nm and
640 nm<λ2<680 nm,
the objective optical system satisfies
1.7×λ1/{n(λ1)−1}≦d≦2.3×λ1/{n(λ1)−1},
where d is the predefined depth of the step difference, and n(λ1) is a refractive index of a material of the second phase structure for the wavelength λ1.

7. The objective optical system of claim 3,
wherein the second phase structure is divided in a plurality of ring-shaped zones on the optical surface including the second phase structure,
each of the ring-shaped zones has a center arranged on the optical axis,
every adjoining ring-shaped zones are divided through a step difference with a predefined depth parallel to an optical axis, and
when the wavelengths λ1 and λ2 satisfy the following expressions:
390 nm<λ1<420 nm and
640 nm<λ2<680 nm,
the objective optical system satisfies
4.7×λ1/{n(λ1)−1}≦d≦5.3×λ1/{n(λ1)−1},
where d is the predefined depth of the step difference, and n(λ1) is a refractive index of a material of the second phase structure for the wavelength λ1.

8. The objective optical system of claim 1, further comprising a second phase structure on one of optical surfaces of the first optical element and the second optical element,
wherein a wavefront aberration change amount caused by the second phase structure on the information recording surface of the first optical information recording medium satisfies 0.033 λ1 rms or more, and 0.120 λ1 rms or less when a wavelength of the first light flux changes +5 nm from the wavelength λ1, and
a wavefront aberration change amount caused by the second phase structure on the information recording surface of the first optical information recording medium satisfies 0.020 λ1 rms or more, and 0.060 λ1 rms or less when an ambient temperature of the objective optical system changes +30° C. from a design reference temperature.

9. The objective optical system of claim 8,
wherein a wavefront aberration change amount caused by the second phase structure when a wavelength of the first light flux changes +1 nm from the wavelength λ1,
is larger than a wavefront aberration change amount caused by the second phase structure when the ambient temperature of the objective optical system changes +10° C. from the design reference temperature, and
is smaller than a wavefront aberration change amount caused by the second phase structure when the ambient temperature of the objective optical system changes +30° C. from the design reference temperature.

10. The objective optical system of claim 8,
wherein the optical surface including the second phase structure is one of an optical surface facing a light source side of the first optical element, an optical surface facing an optical information recording medium side of the first optical element, and an optical surface facing a light source side of the second optical element.

11. The objective optical system of claim 1,
wherein the objective optical system satisfies
0.04<P1/P<0.15
where P1 is a refractive power of the first optical element, and P is a composite power of the first optical element and the second optical element.

12. The objective optical system of claim 1,
wherein the first phase structure generates a first order diffracted light flux with a maximum light amount when the first light flux with the wavelength λ1 passes the first phase structure, and
generates a first order diffracted light flux with a maximum light amount when the second light flux with the wavelength λ2 passes the first phase structure.

13. The objective optical system of claim 8,
wherein the second phase structure is divided in a plurality of ring-shaped zones on the optical surface including the second phase structure,
each of the ring-shaped zones has a center arranged on the optical axis,
every adjoining ring-shaped zones are divided through a step difference with a predefined depth parallel to an optical axis, and
when the wavelengths λ1 and λ2 satisfy the following expressions:
390 nm<λ1<420 nm and
640 nm<λ2<680 nm,
the objective optical system satisfies
1.7×λ1/{n(λ1)−1}≦d≦2.3×λ1/{n(λ1)−1},
where d is the predefined depth of the step difference, and n(λ1) is a refractive index of a material of the second phase structure for the wavelength λ1.

14. The objective optical system of claim 8,
wherein the second phase structure is divided in a plurality of ring-shaped zones on the optical surface including the second phase structure,
each of the ring-shaped zones has a center arranged on the optical axis,
every adjoining ring-shaped zones are divided through a step difference with a predefined depth parallel to an optical axis, and
when the wavelengths λ1 and λ2 satisfy the following expressions:
390 nm<λ1<420 nm and
640 nm<λ2<680 nm,
the objective optical system satisfies
4.7×λ1/{n(λ1)−1}≦d≦5.3×λ1/{n(λ1)−1},
where d is the predefined depth of the step difference, and n(λ1) is a refractive index of a material of the second phase structure for the wavelength λ1.

15. The objective optical system of claim 1,
wherein the objective optical system is for use in the optical pickup apparatus further for recording or reproducing information on an information recording surface of a third optical information recording medium having a protective layer with a thickness t3 by converging a third light flux with a wavelength λ3 (λ2<λ3) emitted from a third light source on the information recording surface of the third optical information recording medium through the protective layer with the thickness t3, and
wherein the first phase structure reduces a spherical aberration caused by a difference between the thickness t1 and the thickness t3.

16. The objective optical system of claim 15,
wherein the objective optical system satisfies
0.04<P1/P<0.11
where P1 is a refractive power of the first optical element, and P is a composite power of the first optical element and the second optical element.

17. The objective optical system of claim 15,
wherein the thicknesses t1, t2, and t3 satisfy t1≦t2<t3, and
wherein the first phase structure generates a first order diffracted light flux with a maximum light amount when the first light flux passes the first phase structure,
generates a first order diffracted light flux with a maximum light amount when the second light flux passes the first phase structure, and
generates a first order diffracted light flux with a maximum light amount when the third light flux passes the first phase structure.

18. The objective optical system of claim 15,
wherein the second phase structure is divided in a plurality of ring-shaped zones on the optical surface including the second phase structure,
each of the ring-shaped zones has a center arranged on the optical axis,
every adjoining ring-shaped zones are divided through a step difference with a predefined depth parallel to an optical axis, and
when the wavelengths λ1, λ2 and λ3 satisfy the following expressions:
390 nm<λ1<420 nm,
640 nm<λ2<680 nm, and
760 nm<λ3<805 nm,
the objective optical system satisfies
1.7×λ1/{n(λ1)−1}≦d≦2.3×λ1/{n(λ1)−1},
where d is the predefined depth of the step difference, and n(λ1) is a refractive index of a material of the second phase structure for the wavelength λ1.

19. The objective optical system of claim 15,
wherein the second phase structure is divided in a plurality of ring-shaped zones on the optical surface including the second phase structure,
each of the ring-shaped zones has a center arranged on the optical axis,
every adjoining ring-shaped zones are divided through a step difference with a predefined depth parallel to an optical axis, and
when the wavelengths λ1, λ2 and λ3 satisfy the following expressions:
390 nm<λ1<420 nm,
640 nm<λ2<680 nm, and
760 nm<λ3<805 nm,
the objective optical system satisfies
9.7×λ1/{n(λ1)−1}≦d≦10.3×λ1/{n(λ1)−1},
where d is the predefined depth of the step difference, and n(λ1 ) is a refractive index of a material of the second phase structure for the wavelength λ1.

20. An optical pickup apparatus comprising:
a first light source emitting a first light flux with a wavelength λ1 for recording and/or reproducing information on an information recording surface of a first optical information recording medium having a protective layer with a thickness t1;
a second light source emitting a second light flux with a wavelength λ2 (λ1<λ2) for recording and/or reproducing information on an information recording surface of a second optical information recording medium having a protective layer with a thickness t2 (t2>t1); and
the objective optical system of claim 1.

21. The optical pickup apparatus of claim 20 further comprising:
a third light source emitting a third light flux with a wavelength λ3 (λ2<λ3) for recording and/or reproducing information on an information recording surface of a third optical information recording medium having a protective layer with a thickness t3,
wherein the first phase structure in the objective optical system reduces a spherical aberration caused by a difference between the thickness t1 and the thickness t3.
